(19) United States
(12) Patent Application Publication
(10) Pub. No.: US 2014/0172166 A1
(43) Pub. Date: Jun. 19, 2014

(54) TREATMENT DEVICE FOR HEMIPLEGIA

(71) Applicant: SNU R&DB Foundation, Seoul (KR)

(72) Inventors: Sung Wan Kim, Seoul (KR); Sun Gun Chung, Seoul (KR); Hee Chan Kim, Seoul (KR); Jae Won Beom, Seoul (KR); Hyung Seok Nam, Seoul (KR); Chi Won Lee, Gyeonggi-do (KR)

(73) Assignee: SNU R&DB Foundation, Seoul (KR)

(21) Appl. No.: 14/013,124

(22) Filed: Aug. 29, 2013

(30) Foreign Application Priority Data
Aug. 30, 2012 (KR) 10-2012-0095936
Jul. 25, 2013 (KR) 10-2013-0088211

(51) Int. Cl. B25J 9/00; A61H 1/00; B25J 9/16

(52) U.S. Cl. CPC B25J 9/0006; B25J 9/1602; B25J 9/1697; A61H 1/00; Y10S 901/02; Y10S 901/47
USPC 700/259; 700/245; 700/258; 601/5; 901/2; 901/47

(57) ABSTRACT

The treatment device for hemiplegia comprises a robot which is putted on the hemiplegic side of the body of a subject; a motion measurement unit for measuring the motion of the healthy side of the body of the subject; and a control which is connected with the robot and the motion measurement unit, wherein the control unit is configured to receive the healthy side's motion measured by the motion measurement unit and to control the robot, whereby the hemiplegic side having the robot put thereon moves in accordance with the motion of the healthy side of the body.

### RELATED APPLICATIONS

This application claims the benefit of priority of Korean Patent Application Nos. 10-2012-0095936 filed on Aug. 30, 2012 and 10-2013-0088211 filed on Jul. 25, 2013. The contents of the above applications are all incorporated by reference as if fully set forth herein in their entirety.

### FIELD AND BACKGROUND OF THE INVENTION

The present invention relates to a system for treating hemiplegia, and more particularly to a system for treating hemiplegia by inducing brain plasticity in a hemiplegia patient using a mirror robot and a robot that performs a pre-programmed specific motion on the hemiplegic side of the body.

Currently, it is known that portions of the brain perform the respective functions. Thus, when a specific portion of the brain is damaged by stroke, traumatic brain injury, brain tumor or the like, hemiplegia can occur.

As used herein, the term “hemiplegia” refers to a situation in which a movement disorder of an upper or lower limb or a facial portion at one side of the body occurred.

The treatment of hemiplegia according to the prior art generally relies on joint movement or the simple repletion of movement. Also, robots such as a wearable walking assistance robot suit disclosed in Korean Patent Registration No. 10-1099521 show a very insignificant effect on the treatment of hemiplegia, and thus are regarded as medical auxiliary devices rather than treatment devices.

The present invention aims to solve the above-described problems occurring in the prior art and to provide an effective system for treating hemiplegia using brain plasticity.

As used herein, the term “neuroplasticity or brain plasticity” is a compound word of neuron and plasticity and refers to the brain's ability to change its function and its structure through thinking and action.

In other words, in the case of hemiplegic patients, brain plasticity can be induced so that portions other than the damaged portion of the brain perform the motor function of the hemiplegic side.

Brain plasticity can be positively influenced by the observation of action as described in detail in the literature (Calvo-Merino et al., “Action Observation and Acquired Motor Skills: An fMRI Study with Expert Dancers”, Oxford University Press 2005, p. 1243-1249; Denis Ertelt et al., “Action observation has a positive impact on rehabilitation of motor deficits after stroke”, NeuroImage 36, 2007, p. T164-T173) which is incorporated herein by reference.

Such action observation can be maximized by a mirror effect as described in detail in the literature (Christian Dohle et al., “Mirror therapy promotes recovery from severe hemiparesis: a randomized controlled trial”, Neurorehabilitation and Neural Repair, 2009, p. 209-217; Holm Thieme et al., “Mirror therapy for improving motor function after stroke”, Cochrane Database of Systematic Reviews, 2012, 14; 3: CD008449.

Particularly, the applicant has found through experiments that, when a hemiplegic patient has a visual illusion that the hemiplegic side of the body normally moves, the induction of brain plasticity is maximized.

The present invention aims to allow the hemiplegic side of the body to be actually moved by the exoskeleton or the like to thereby induce brain plasticity greater than a therapeutic effect caused by the mirror effect, thereby contributing to the treatment of hemiplegia.

### SUMMARY OF THE INVENTION

Accordingly, the present invention has been made in order to solve the above problems occurring in the prior art, and an object of the present invention is to provide a system for treating hemiplegia, which can induce brain plasticity for effective rehabilitation.

Another object of the present invention is to provide a system for treating hemiplegia, which includes an auxiliary device (screen, visual separation device, or mirror) which can cause the patient's illusion by the mirror effect so as to maximize the induction of brain plasticity.

In order to accomplish the above objects, the present invention provides a system for treating hemiplegia, comprising: a robot which is putted on the hemiplegic side of the body of a subject; and a control unit which is connected with the robot and in which a specific motion is pre-programmed, wherein the control unit is configured to control the robot such that the hemiplegic side moves in accordance with the pre-programmed specific motion.

The present invention also provides a system for treating hemiplegia, comprising: a robot which is putted on the hemiplegic side of the body of a subject; a motion measurement unit for measuring the motion of the healthy side of the body of the subject; and a control which is connected with the robot and the motion measurement unit; wherein the control unit is configured to receive the healthy side's motion measured by the motion measurement unit and to control the robot such that the hemiplegic side of the body moves in accordance with the motion of the healthy side of the body.

Preferably, the system for treating hemiplegia according to the present invention further comprises a screen, and the screen is configured to obstruct the visual field of the subject so that the subject is not capable of seeing the motion of the healthy side.

Preferably, the system for treating hemiplegia according to the present invention further comprises a mirror, and the mirror is configured to obstruct the visual field of the subject such that the subject is not capable of seeing the motion of the hemiplegic side of the body.

Preferably, the system for treating hemiplegia according to the present invention further comprises shielding spectacles, and the shielding spectacles are configured to obstruct the visual field of the subject such that the subject is not capable of seeing the motion of the healthy side of the body.

Preferably, the system for treating hemiplegia according to the present invention further comprises simulation spectacles, and the simulation spectacles are configured to cause a visual perceptual illusion and display simulation.

Preferably, the system of the present invention is configured such that the subject observes only the motion of the hemiplegic side to induce brain plasticity in the subject.

Preferably, the system of the present invention is configured such that the hemiplegic side having the robot put thereon moves in accordance with the motion of the healthy side in real time under the control of the control unit.

Preferably, the system of the present invention is configured such that the hemiplegic side having the robot put thereon moves in accordance with the pre-programmed motion stored in the control unit.

Preferably, the motion measurement unit is a motion capture device.

Preferably, the motion capture device comprises: a plurality of markers that are attached to the healthy side; a camera that photographs the movement of the plurality of markers; and a motion capture process that produces a digital representation using the movement of the plurality of markers photographed by the camera, wherein the digital representation produced by the motion capture processor is input into the control unit, and the control unit is configured to control the robot in accordance with the input digital representation.

Preferably, the motion capture device comprises: a camera that photographs the motion of the healthy side; and a motion capture process that produces a digital representation using the motion of the healthy side photographed by the camera, wherein the digital representation produced by the motion capture processor is input into the control unit, and the control unit is configured to control the robot in accordance with the input digital representation.

Preferably, the motion measurement unit is an electromyogram (EMG) sensor, and the EMG sensor is configured to measure the motion of the healthy side by receiving the electromyogram signal of the healthy side.

Preferably, the motion measurement unit is an inertial measurement unit (IMU) or an attitude and heading reference system (AHRS).

Preferably, the body is an arm, and the robot comprises: a shoulder mounting portion that is fixed to the shoulder of the arm; an upper arm fixing portion that is connected with the shoulder mounting portion at one end and fixed to the upper portion of the arm; a joint portion that is connected to the other end of the upper arm fixing portion; a forearm fixing portion that is connected with the shoulder mounting portion at the other end and fixed to the lower portion of the arm; and a grip portion which is connected with the other end of the forearm fixing portion and in which the hand of the arm is located, wherein the joint portion is configured to rotate the forearm fixing portion with respect to the upper arm fixing unit under the control of the control unit.

Preferably, the body is a leg, and the robot comprises: a waist fixing portion that is fixed to the waist of the body; a femur fixing portion that is connected with the waist fixing portion at one end and fixed to the femur of the leg; a knee joint portion that is connected with the other end of the femur fixing portion; a lower leg fixing portion that is connected with the knee joint portion at one end and fixed to the lower portion of the leg; and a shoe portion which is connected with the other end of the lower leg fixing portion and in which the foot of the leg is located, wherein the knee joint portion is configured to rotate the lower leg fixing portion with respect to the femur fixing portion under the control of the control unit.

As described above, the system according to the present invention assists in the treatment of hemiplegia by maximizing the induction of brain plasticity.

In addition, the system for treating hemiplegia according to the present invention may also be used as an auxiliary device that assists in the motion of arms and legs and assists in the activities of daily living (ADL).

### BRIEF DESCRIPTION OF THE DRAWINGS

FIG. 1 is a perspective view showing that a subject uses a system for treating hemiplegia according to an embodiment of the present invention.

FIG. 2 is a perspective view showing that a subject uses a system for treating hemiplegia according to another embodiment of the present invention.

FIG. 3 is a perspective view showing an arm robot according to an embodiment of the present invention.

FIG. 4 is a perspective view showing a leg robot according to an embodiment of the present invention.

FIG. 5 shows the construction of an embodiment of the present invention.

### DESCRIPTION OF THE PREFERRED EMBODIMENTS

### Description of Construction of System for Treating Hemiplegia

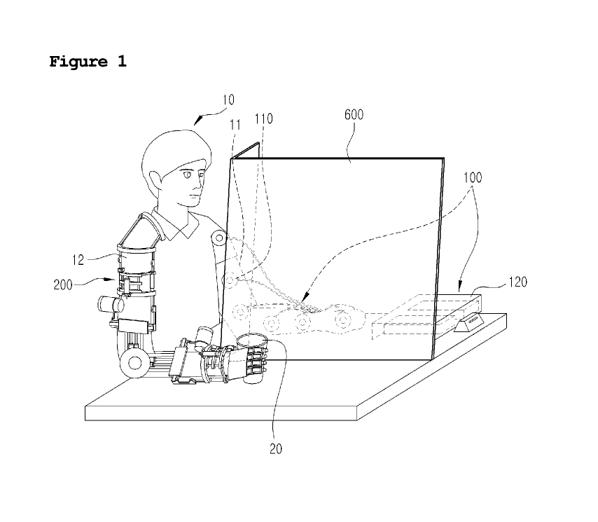

Hereinafter, the system for treating hemiplegia according to the present invention will be described in detail with reference to FIGS. 1 to 4.

The system for treating hemiplegia according to the present invention may comprise a motion measurement unit 100, a robot 200 or 300, a control unit 500 and a screen 600.

The motion measurement unit 100 is configured to measure the motion of the healthy side of the body. Herein, the healthy side of the body is preferably opposite to the hemiplegic side having the robot 200 or 300 put thereon. For example, when the arm robot 200 is put on the hemiplegic arm, the healthy side of the body is a healthy arm. Also, when the leg robot 300 is put on a hemiplegic leg, the healthy side of the body is a healthy leg. In addition, when the robots 200 and 300 are put on a hemiplegic arm and leg, respectively, the healthy side of the body is meant to include a healthy arm and leg.

Such illustration is also applied to a face. When the arm robot 200 is put on the hemiplegic arm, the healthy side may be a healthy leg. However, in this case, it is required to control the arm robot 200 through suitable correction in the control unit 500 as described below.

In an embodiment, the motion measurement unit 100 may be a motion capture device 120.

The motion capture device 120 is configured to produce a digital representation by measuring the motion of the healthy side of the body.

In an embodiment, the motion capture device 120 may comprise markers (not shown), a camera 121 and a motion capture processor 122.

The markers are attached to the healthy side of the body and photographed by the camera 121.

The camera 121 is configured to photograph the plurality of markers attached to the healthy side of the body. In other words, the camera 121 is configured to photograph the movement of the plurality of markers.

The motion capture processor 122 is configured to produce a digital representation using the movement of the plurality of markers photographed by the camera 121. As described below, the digital representation is input into the control unit 500 and used to control the robot.

The motion capture device 120 may, for example, include the camera 121 and the motion capture processor 122.

The camera 121 is configured to photograph the motion of the healthy side of the body. It is to be understood that one or plural cameras 121 may be disposed.

The motion capture processor 122 is configured to produce a digital representation using the motion of the healthy side photographed by the camera 121.

In an embodiment, the motion capture processor 122 may include an instruction for receiving a photographed image from the camera 121, an instruction for distinguishing the motion of the healthy side of the body in the image, and an instruction for producing a digital instruction using the distinguished motion of the healthy side of the body.

The motion capture device 120 may be, for example, Kinect® manufactured by Microsoft Corporation. In addition, it may also be a 3D space recognition camera 121.

In an alternative embodiment, the motion measurement unit 100 may be an electromyogram (EMG) sensor 130.

The electromyogram sensor 130 is configured to measure the motion of the healthy side of the body by receiving the electromyogram signal of the healthy side. The configuration of the electromyogram sensor 130 is known in the art.

In another embodiment, the motion measurement unit 100 may be an inertial measurement unit (IMU) 140 that is a sensor comprising accelerometers and a gyro axis, or an attitude heading reference system (AHRS) 150.

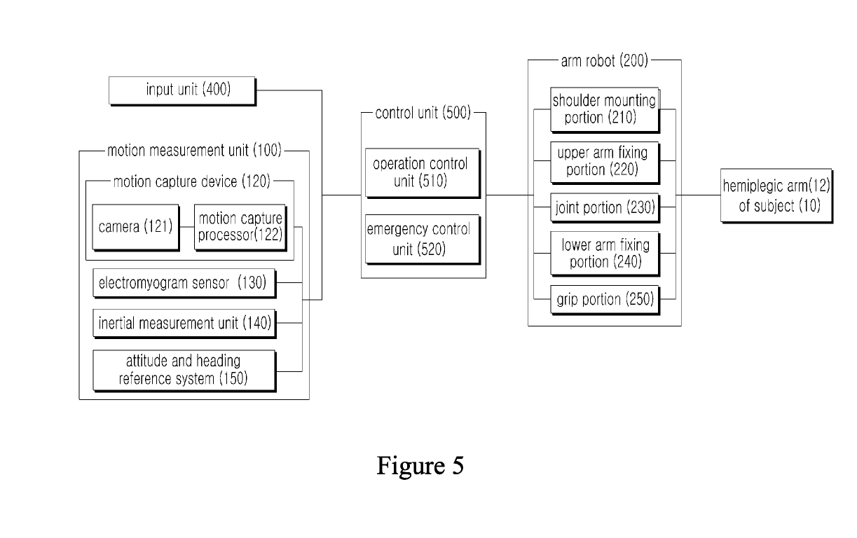

As shown in FIG. 1, and further with reference to FIG. 5, the inertial measurement unit (IMU) 140 or the attitude heading reference system (AHRS) 150 includes a sensor 110, which is attached to the healthy side of the body and includes a plurality of accelerometers and a gyro axis, and a processor (not shown) for inputting the output value of the sensor 110 as a digital representation into the control unit 500, and the digital representation is processed in the control unit 500 to control the robot 200 or 300.

The configuration of the inertial measurement unit (IMU) 140 and the attitude heading reference system (AHRS) 150 is known in the art.

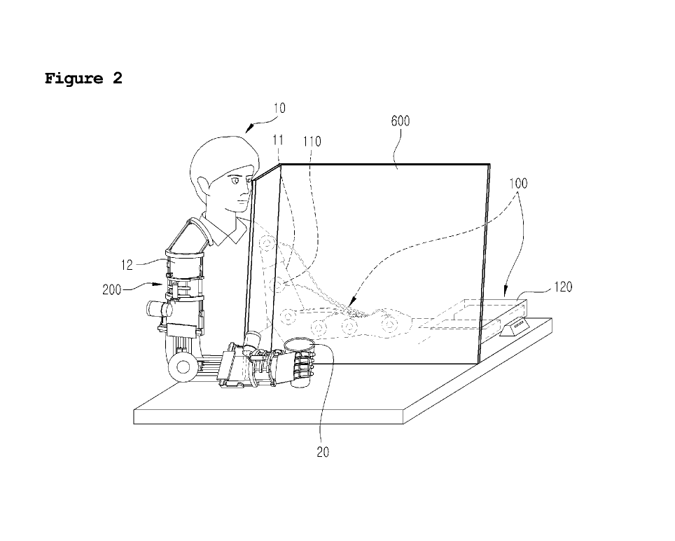

The robot 200 or 300 is put on the hemiplegic side of the body of a subject. As described below, the hemiplegic side having the robot 200 or 300 put thereon may move in accordance with the motion of the healthy side of the body under the control of the control unit 500. The robots 200 and 300 may be an arm robot 200 and a leg robot 300, respectively, but the scope of the present invention is not limited thereto. In FIG. 1 a screen 600 divides between the healthy and hemiplegic sides of the body. FIG. 2 is a variation of FIG. 1, in which a mirror replaces the screen. The difference between the two will be discussed in greater detail hereinbelow.

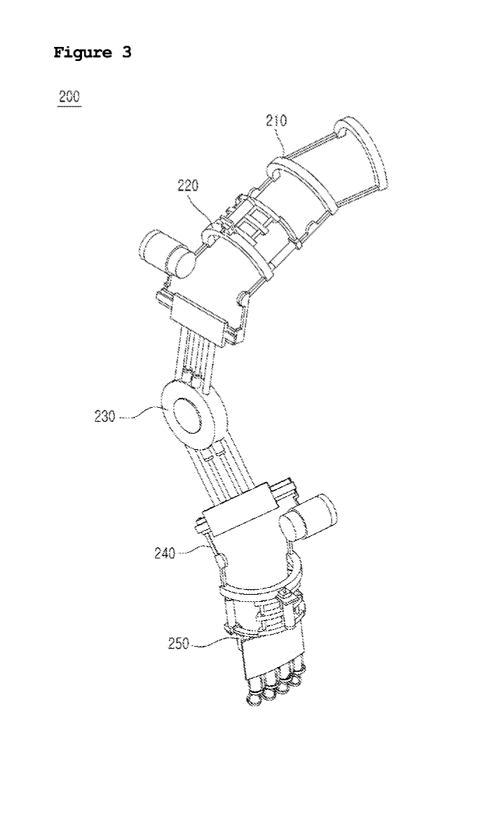

As shown in FIG. 3, the arm robot 200 may comprise a shoulder mounting portion 210, an upper arm fixing portion 220, a joint portion 230, a forearm fixing portion 240 and a grip portion 250.

The shoulder mounting portion 210 is a portion that is configured to be fixed to the shoulder of the hemiplegic arm.

The upper arm fixing portion 220 is connected with the shoulder mounting portion 210 at one end and configured to be fixed to the upper portion of the hemiplegic arm.

The joint portion 230 is connected with the other end of the upper arm fixing portion 220.

The forearm fixing portion 240 is connected with the joint portion 230 at one end and configured to be fixed to the lower portion of the hemiplegic arm.

The grip portion 250 is a portion which is connected with the other end of the forearm fixing portion 240 and in which the hand is located.

In the above-described configuration, the joint portion 230 can rotate the forearm fixing portion 240 with respect to the upper arm fixing portion 220. To produce this rotational movement, the joint portion 230 may comprise a motor (not shown). Also, any joint portion in addition to the joint portion 230 may comprise a motor.

Preferably, the lengths of the upper arm fixing portion 220 and the forearm fixing portion 240 can be controlled or adjusted according to the lengths of the upper and forearm portions of the subject, and the grip portion 250 may be configured to include a metacarpophalangeal joint so that the finger can delicately move.

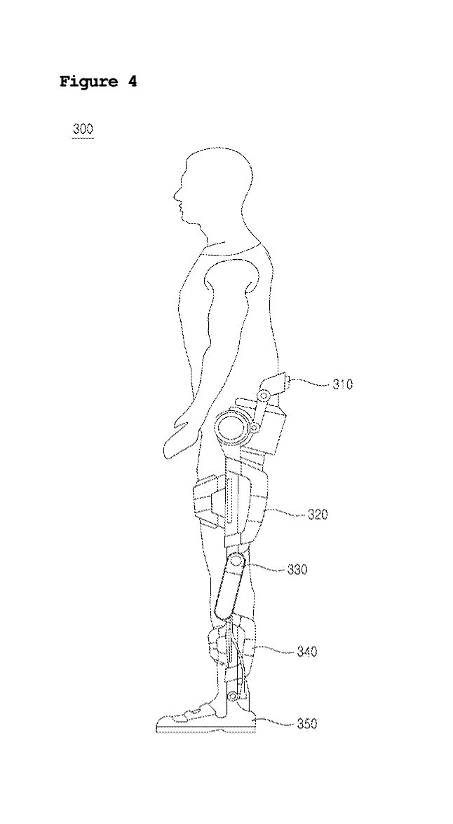

As shown in FIG. 4, the leg robot 300 may comprise a waist fixing portion 310, a femur fixing portion 320, a knee joint portion 330, a lower leg fixing portion 340 and a shoe portion 350.

The waist fixing portion 310 is a portion that is configured to be put on the waist of the subject 10.

The femur fixing portion 320 is connected with the waist fixing portion 310 at one end and configured to be fixed to the femur of the hemiplegic leg.

The knee joint portion 330 is connected with the other end of the femur fixing portion 320.

The lower leg fixing portion 340 is connected with the knee joint portion 330 at one end and configured to be fixed to the lower portion of the hemiplegic leg.

The shoe portion 350 is a portion which is connected with the other end of the lower leg fixing portion 340 and in which the foot is located.

In the above-described configuration, the knee joint portion 330 can rotate the lower leg fixing portion 340 with respect to the femur fixing portion 320. To generate this rotational movement, the knee joint portion 330 may comprise a motor (not shown). Also, any joint portion in addition to the knee joint portion 330 may comprise a motor.

The sizes of all the elements of the leg robot 300 may be controlled or adjusted according to the subject 10.

In addition, it will be obvious to those skilled in the art that the robot 200 or 300 may comprise a signal receiving portion to receive a control signal from the control unit 500.

The control unit 500 is connected with the robot 200 or 300 and the motion measurement unit 100. This connection may be a wire or wireless connection. This connection allows the robot 200 or 300 to be controlled using information, such as a signal, an image or a digital representation, received from the motion measurement unit 100.

The control unit 500 is configured to realize a mirror robot, that is, perform the closed feedback of the motion of the healthy side to the hemiplegic side of the body. In other words, the control unit 500 is configured to receive the motion of the healthy side of the body and control the robot such that the hemiplegic side of the body moves in the same manner as, symmetrically with or in accordance with the healthy side of the body.

The above-described control of the control unit 500 may be performed in real time or almost real time. In some cases, the control unit 500 may comprise a storage unit for storing input actions, and in this case, the robot can also be controlled according to the stored actions.

As shown in FIG. 5, the control unit 500 may comprise an operation control unit 510 and an emergency control unit 520.

The operation control unit 510 mainly controls the robot 200 or 300, but in a state in which the operation control unit 510 cannot control the robot 200 or 300, the emergency control unit 520 controls the robot 200 or 300.

Preferably, the treatment device for hemiplegia according to the present invention may further comprise a screen 600. In an embodiment, the screen 600 is located such that it obstructs the visual field of the subject 10 such that the subject cannot see the motion of the healthy side of the body and can see the motion of the hemiplegic side of the body, thereby enhancing the degree of a perceptual illusion and maximizing the brain plasticity.

In the embodiment shown in FIG. 1, the screen 600 is preferably made of an opaque material in order to obstruct the visual field of the subject.

However, the scope of the present invention is not limited to the above embodiment, and the screen 600 may be configured to have any shape in any place such that the subject cannot see the motion of the healthy side of the body and can see the motion of the hemiplegic side of the body.

In another embodiment, the screen 600 may be made of a mirror. Specifically, as shown in FIG. 2, the screen 600 may be configured to obstruct the visual field of the subject 10 such that the subject cannot see the motion of the hemiplegic side of the body and can see the motion of the healthy side of the body.

In this case, the subject sees the motion of the healthy side of the body and, at the same time, has an illusion that the healthy side's motion which is symmetrically mirrored on the screen 600 is the motion of the opposite hemiplegic side of the body. Thus, the mirror image effect can be maximized using the mirror, thereby enhancing the degree of a perceptual illusion of the brain and maximizing the induction of brain plasticity.

Preferably, the treatment device for hemiplegia according to the present invention may comprise shielding spectacles (not shown) in place of the screen 600. The shielding spectacles may be put on the subject so that the subject cannot see the motion of the healthy side of the body and can see the motion of the hemiplegic side of the body.

Preferably, the treatment device for hemiplegia according to the present invention may comprise simulation spectacles (not shown) in place of the screen 600. The simulation spectacles can show a display that assists in simulating a specific motion of the healthy side of the body. The simulation spectacles can also be used such that the subject cannot see the motion of the healthy side of the body.

The treatment device for hemiplegia according to another embodiment of the present invention may comprise a robot 200 or 300, an input unit 400, a control unit 500 and a screen 600.

The robot 200 or 300, the control unit 500 and the screen 600 are as described above, and thus omitted.

The input unit 400 is connected to the control unit 500 and may be configured to program a specific motion into the control unit 500. The control unit 500 is configured to control the robot 200 or 300 so as to correspond to the specific motion pre-programmed into the control unit 500. As described in the above embodiment, the control unit 500 may also be configured to control the robot 200 or 300 in accordance with not only the specific motion input by the input unit 400, but also the motion measured by the motion measurement unit 100.

In this embodiment, brain plasticity can be maximized using the screen 600, a mirror, shielding spectacles or simulation spectacles.

Description of Method for Treating Hemiplegia Using the Hemiplegia Treatment System

Hereinafter, a method for treating hemiplegia using the hemiplegia treatment system according to an embodiment of the present invention will be described in detail with reference to FIG. 1. It is to be understood, however, that this description is for illustrative purposes only and are not intended to limit the scope of the present invention.

FIG. 1 is a perspective view showing that the subject 10 uses the hemiplegia treatment system according to an embodiment of the present invention. The left arm of the subject 10 is a healthy arm 11, and the right arm is a hemiplegic arm 12. The robot 200 is put on the hemiplegic arm 12. Also, a cup 20 is gripped by the hand of the hemiplegic arm 12.

The subject 10 cannot see the motion of the healthy arm 11 of the body, but can see the motion of the hemiplegic arm 12.

The subject 10 moves the healthy arm 11 in order to perform activities of daily life, such as drinking water with a cup.

The motion capture device 120 measures the motion of the healthy arm 11 and inputs information such as a digital representation into the control unit 500.

Using the input information, the control unit 500 controls the arm robot 200 on the hemiplegic arm 12 in accordance with the motion of the healthy arm 11.

At this time, the hemiplegic arm 12 is moved by the arm robot 200 in accordance with the motion of the healthy arm 11, like drinking water with a cup.

This procedure may be performed in real-time, and the subject 10 cannot see the motion of the healthy arm 11 of the body as well as the motion of the hemiplegic arm 12 directly, but only sees the reflected image of the healthy arm 11, and thus has a visual illusion that the hemiplegic arm 12 normally moves, whereby the induction of brain plasticity is maximized.

As shown in FIG. 2, when a mirror is used as the screen 600, the subject can see the motion of the healthy arm 11 of the body and, at the same time, has a visual illusion that the motion of the healthy arm 11 that is reflected on the mirror is the motion of the hemiplegic arm 12, whereby the induction of brain plasticity is maximized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A treatment device for hemiplegia, comprising:
a robot which is putted on the hemiplegic side of the body of a subject; and
a control unit which is connected with the robot and in which a specific motion is pre-programmed,
wherein the control unit is configured to control the robot such that the hemiplegic side of the body moves in accordance with the pre-programmed specific motion.

2. A treatment device for hemiplegia, comprising:
a robot which is putted on the hemiplegic side of the body of a subject;
a motion measurement unit for measuring the motion of the healthy side of the body of the subject; and
a control which is connected with the robot and the motion measurement unit,
wherein the control unit is configured to receive the healthy side's motion measured by the motion measurement unit and to control the robot such that the hemiplegic side of the body moves in accordance with the motion of the healthy side of the body.

3. The device of claim 1, wherein the device further comprises a screen, and the screen is configured to obstruct the visual field of the subject so that the subject is not capable of seeing the motion of the healthy side of the body.

4. The device of claim 2, wherein the device further comprises a screen, and the screen is configured to obstruct the visual field of the subject so that the subject is not capable of seeing the motion of the healthy side of the body.

5. The device of claim 1, wherein the device further comprises a mirror, and the mirror is configured to obstruct the visual field of the subject such that the subject is not capable of seeing the motion of the hemiplegic side of the body.

6. The device of claim 2, wherein the device further comprises a mirror, and the mirror is configured to obstruct the visual field of the subject such that the subject is not capable of seeing the motion of the hemiplegic side of the body.

7. The device of claim 1, wherein the device further comprises shielding spectacles, and the shielding spectacles are configured to obstruct the visual field of the subject such that the subject is not capable of seeing the motion of the healthy side of the body.

8. The device of claim 2, wherein the device further comprises shielding spectacles, and the shielding spectacles are configured to obstruct the visual field of the subject such that the subject is not capable of seeing the motion of the healthy side of the body.

9. The device of claim 1, wherein the device further comprises simulation spectacles, and the simulation spectacles are configured to cause a visual perceptual illusion and display simulation.

10. The device of claim 2, wherein the device further comprises simulation spectacles, and the simulation spectacles are configured to cause a visual perceptual illusion and display simulation.

11. The device of claim 3, wherein the device is configured such that the subject observes only the motion of the hemiplegic side to induce brain plasticity in the subject.

12. The device of claim 4, wherein the device is configured such that the subject observes only the motion of the hemiplegic side to induce brain plasticity in the subject.

13. The device of claim 2, wherein the device is configured such that the hemiplegic side having the robot put thereon moves in accordance with the motion of the healthy side in real time under the control of the control unit.

14. The device of claim 2, wherein the device is configured such that the hemiplegic side having the robot put thereon moves in accordance with the pre-programmed motion stored in the control unit.

15. The device of claim 2, wherein the motion measurement unit is a motion capture device.

16. The device of claim 15, wherein the motion capture device comprises:
a plurality of markers that are attached to the healthy side;
a camera that photographs the movement of the plurality of markers; and
a motion capture process that produces a digital representation using the movement of the plurality of markers photographed by the camera,
wherein the digital representation produced by the motion capture processor is input into the control unit, and the control unit is configured to control the robot in accordance with the input digital representation.

17. The device of claim 15, wherein the motion capture device comprises: a camera that photographs the motion of the healthy side; and
a motion capture process that produces a digital representation using the motion of the healthy side photographed by the camera,
wherein the digital representation produced by the motion capture processor is input into the control unit, and the control unit is configured to control the robot in accordance with the input digital representation.

18. The device of claim 2, wherein the motion measurement unit is an electromyogram (EMG) sensor, and the EMG sensor is configured to measure the motion of the healthy side by receiving the electromyogram signal of the healthy side of the body.

19. The device of claim 2, wherein the motion measurement unit is an inertial measurement unit (IMU) or an attitude and heading reference system (AHRS).

20. The device of claim 1, wherein the body is an arm, and the robot comprises:
a shoulder mounting portion that is fixed to the shoulder of the arm;
an upper arm fixing portion that is connected with the shoulder mounting portion at one end and fixed to the upper portion of the arm;
a joint portion that is connected to the other end of the upper arm fixing portion;
a forearm fixing portion that is connected with the shoulder mounting portion at the other end and fixed to the lower portion of the arm; and
a grip portion which is connected with the other end of the forearm fixing portion and in which the hand of the arm is located,
wherein the joint portion is configured to rotate the forearm fixing portion with respect to the upper arm fixing unit under the control of the control unit.

21. The device of claim 2, wherein the body is an arm, and the robot comprises:
a shoulder mounting portion that is fixed to the shoulder of the arm;
an upper arm fixing portion that is connected with the shoulder mounting portion at one end and fixed to the upper portion of the arm;
a joint portion that is connected to the other end of the upper arm fixing portion;
a forearm fixing portion that is connected with the shoulder mounting portion at the other end and fixed to the lower portion of the arm; and
a grip portion which is connected with the other end of the forearm fixing portion and in which the hand of the arm is located,
wherein the joint portion is configured to rotate the forearm fixing portion with respect to the upper arm fixing unit under the control of the control unit.

22. The device of claim 1, wherein the body is a leg, and the robot comprises:
a waist fixing portion that is fixed to the waist of the body;
a femur fixing portion that is connected with the waist fixing portion at one end and fixed to the femur of the leg;
a knee joint portion that is connected with the other end of the femur fixing portion;
a lower leg fixing portion that is connected with the knee joint portion at one end and fixed to the lower portion of the leg; and
a shoe portion which is connected with the other end of the lower leg fixing portion and in which the foot of the leg is located,
wherein the knee joint portion is configured to rotate the lower leg fixing portion with respect to the femur fixing portion under the control of the control unit.

23. The device of claim 2, wherein the body is a leg, and the robot comprises:
a waist fixing portion that is fixed to the waist of the body;
a femur fixing portion that is connected with the waist fixing portion at one end and fixed to the femur of the leg;
a knee joint portion that is connected with the other end of the femur fixing portion;
a lower leg fixing portion that is connected with the knee joint portion at one end and fixed to the lower portion of the leg; and
a shoe portion which is connected with the other end of the lower leg fixing portion and in which the foot of the leg is located,
wherein the knee joint portion is configured to rotate the lower leg fixing portion with respect to the femur fixing portion under the control of the control unit.
